(19) United States
(12) Patent Application Publication
(10) Pub. No.: US 2023/0172270 A1
(43) Pub. Date: Jun. 8, 2023

(54) LOW-TEMPERATURE SMOKING SET

(71) Applicant: SHENZHEN FIRST UNION TECHNOLOGY CO.,LTD., Shenzhen Guangdong Province (CN)

(72) Inventors: Ruilong HU, Shenzhen Guangdong Province (CN); Wei CHEN, Shenzhen Guangdong Province (CN); Zhongli XU, Shenzhen Guangdong Province (CN); Yonghai LI, Shenzhen Guangdong Province (CN)

(73) Assignee: SHENZHEN FIRST UNION TECHNOLOGY CO.,LTD., Shenzhen Guangdong Province (CN)

(21) Appl. No.: 17/758,882

(22) PCT Filed: Jan. 15, 2021
(86) PCT No.: PCT/CN2021/072133

§ 371 Date: Dec. 20, 2022

(30) Foreign Application Priority Data
Jan. 16, 2020 (CN) 202020095304.1

(51) Int. Cl. A24F 40/46; A24F 40/20; A24F 40/50

(52) U.S. Cl. CPC A24F 40/46; A24F 40/20; A24F 40/50

(57) ABSTRACT

A low-temperature smoking set, comprising a housing assembly (1) and a heating assembly (4) disposed in the housing assembly (1), wherein a cavity (121) used for inserting a cigarette (10) is provided on the housing assembly (1), and a cigarette accommodating cavity (P1) used for accommodating at least a part of the cigarette (10) is provided at the inner part of the housing assembly (1). At least one cigarette holding mechanism (5) is disposed at the cavity wall of the cigarette accommodating cavity (P1). The cigarette holding mechanism (5) comprises at least two deformable elastic protrusion parts (P2) arranged at intervals along the circumference of the cigarette accommodating cavity (P1). The elastic protrusion parts (P2) are in the shape of sheets and extend from the cavity wall of the cigarette accommodating cavity (P1) toward the inner part of the cigarette accommodating cavity (P1) along the radial direction of the cigarette accommodating cavity (P1), thereby implementing adaptive adjustment according to the diameter of the cigarette (10) so as to adapt to cigarettes of different diameters (10). In addition, since the elastic protrusion parts (P2) are in the shape of sheets, heat dissipation may be better prevented, thereby ensuring the baking efficiency of the cigarette (10).

This application claims priority to Chinese Patent Application No. 202020095304.1, entitled “Low-temperature smoking set” and submitted to China National Intellectual Property Administration on Jan. 16, 2020, the entire content of which is incorporated herein by reference.

### TECHNICAL FIELD

The present disclosure relates to the technical field of low-temperature smoking sets, and in particular to a low-temperature smoking set.

### BACKGROUND

Traditional cigarettes made from tobacco need to be lit by fire and then burn to produce smoke. During the process of high-temperature pyrolysis, the tobacco releases thousands of harmful mixed substances, which are composed of volatile substances in gases and semi-volatile and non-volatile substances in particles, such as carbon monoxide, phenols, aldehydes, nicotine, tobacco tar, etc. Low temperature smoke can effectively reduce the production of harmful substances and is healthier.

Therefore, low-temperature smoking sets emerge accordingly. Currently, common low-temperature smoking sets generally are divided into a central heating type and a surrounding heating type, and the general structure is that: a cigarette accommodating cavity is disposed in the smoking set, a heating body is located within the cigarette accommodating cavity (the central heating type), when the cigarette is heated, the heating body is inserted into the interior of the cigarette, or the heating body is located at the surrounding of the cigarette accommodating cavity (the surrounding heating type), when the cigarette is heated, the heating body is located the surrounding of the cigarette (that is, the cigarette is disposed in the interior of the heating body), and during usage, the heating body is supplied with power to generate heat, thereby heating the cigarette within the cigarette accommodating cavity.

Low-temperature smoking sets generally select different cigarette fixing structures depending on the diameter of the cigarettes. That is to say, different heating modules are used for cigarettes of different diameters. If an infrared heating technology is employed, since it is radiant heat transfer, the heating tube does not need to tightly adhere to the cigarette, then those cigarettes with a difference within 0.5 mm in diameter may share the heating tube. However, the inner diameter of the cigarette clamping structure needs to be adjusted according to cigarettes too, consequently cigarette clamping structures with a minor difference in size are repeatedly developed. In addition, during the process of usage, if a user needs to smoke a cigarette of a different diameter, he/she needs to use a different smoking set, which is inconvenient.

### SUMMARY

In order to solve the problems in existing technologies, the present disclosure provides a low-temperature smoking set applicable to cigarettes of different diameters.

The present disclosure provides a low-temperature smoking set, including a housing assembly and a heating assembly disposed inside the housing assembly, the housing assembly defining thereon a cavity opening used for inserting a cigarette, and an inner part of the housing assembly being provided with a cigarette accommodating cavity used for accommodating at least part of the cigarette, wherein at least one cigarette holding mechanism is disposed at a cavity wall of the cigarette accommodating cavity, the cigarette holding mechanism includes at least two deformable elastic protrusion parts arranged at intervals along the circumference of the cigarette accommodating cavity, the elastic protrusion parts are in the shape of a sheet and extend from the cavity wall of the cigarette accommodating cavity toward an inner part of the cigarette accommodating cavity along the radial direction of the cigarette accommodating cavity.

Preferably, the cigarette accommodating cavity is provided with a proximal end close to the cavity opening and a distal end away from the cavity opening and extends from the proximal end toward the distal end along an axial line, and the at least one cigarette holding mechanism is disposed at the proximal end of the cigarette accommodating cavity.

Preferably, the cigarette holding mechanism includes a first elastic protrusion part and a second elastic protrusion part, the first elastic protrusion part and the second elastic protrusion part are symmetrical with respect to the axial line of the cigarette accommodating cavity.

Preferably, a spacing between the first elastic protrusion part and the second elastic protrusion part along the radial direction of the cigarette accommodating cavity is less than a caliber of the cavity opening.

Preferably, the at least one cigarette holding mechanism includes a first cigarette holding mechanism located at the proximal end of the cigarette accommodating cavity and a second cigarette holding mechanism located at the distal end of the cigarette accommodating cavity.

Preferably, the elastic protrusion part is provided with a curved butting surface used for abutting against the cigarette.

Preferably, the heating assembly includes a base and an infrared radiation generation layer bonded to a surface of the base, the base is in the shape of a tube and an inner part thereof forms the cigarette accommodating cavity.

Preferably, the heating assembly includes a heating body and a first fixing seat, the heating body is used for heating the cigarette, and the first fixing seat is connected to the heating body;

the cigarette holding mechanism further includes a sleeving ring part and a connection part, the sleeving ring part is sleeved on the first fixing seat, one end of the sleeving ring part extends toward an axial center of the sleeving ring part to form a plurality of the elastic protrusion parts, one end of the connection part is connected to one of the elastic protrusion parts and the other end of the connection part is connected to another of the elastic protrusion parts.

Preferably, the connection part and the elastic protrusion part extend along and within one same plane that is perpendicular to the axial line of the cigarette accommodating cavity.

Preferably, the cigarette holding mechanism is a part made of a silicone rubber material.

The present disclosure has the following beneficial effects. At least one cigarette holding mechanism is disposed at the cavity wall of the cigarette accommodating cavity, the cigarette holding mechanism includes at least two deformable elastic protrusion parts arranged at intervals along the circumference of the cigarette accommodating cavity, and the elastic protrusion part is used for abutting against the cigarette, therefore, when a cigarette with a greater diameter is inserted into the cigarette accommodating cavity, the elastic protrusion part generates an elastic deformation such that the cigarette can be inserted into the cigarette accommodating cavity, thereby implementing adaptive adjustment according to the diameter of the cigarette so as to adapt to cigarettes of different diameters. In addition, since the elastic protrusion parts are in the shape of a sheet and extend from the cavity wall of the cigarette accommodating cavity toward the inner part of the cigarette accommodating cavity along the radial direction of the cigarette accommodating cavity, heat dissipation may be better prevented, thereby ensuring the heating efficiency of the cigarette.

### BRIEF DESCRIPTION OF THE DRAWINGS

One or more embodiments are illustrated through the image(s) in corresponding drawing(s). These illustrations do not form restrictions to the embodiments. Elements in the drawings with a same reference number are expressed as similar elements, and the images in the drawings do not form proportional restrictions unless otherwise stated.

FIG. 1 is a perspective view of a low-temperature smoking set according to one embodiment of the present disclosure.

FIG. 2 is a perspective view of the low-temperature smoking set shown in FIG. 1 having a cigarette inserted.

FIG. 3 is a sectional view of the low-temperature smoking set shown in FIG. 1.

FIG. 4 is a perspective view of the combination of a heating assembly and a cigarette holding mechanism in the low-temperature smoking set shown in FIG. 1.

FIG. 5 is an exploded view of a heating assembly and a cigarette holding mechanism in the low-temperature smoking set shown in FIG. 1.

FIG. 6 is a perspective view of a cigarette holding mechanism in the low-temperature smoking set shown in FIG. 1.

FIG. 7 is a sectional view of a low-temperature smoking set according to another embodiment of the present disclosure.

FIG. 8 is a perspective view of a second cigarette holding mechanism in the low-temperature smoking set shown in FIG. 7.

### DETAILED DESCRIPTION

The present disclosure will become better understood from a detailed description of the present disclosure below taken in conjunction with drawings and particular embodiments.

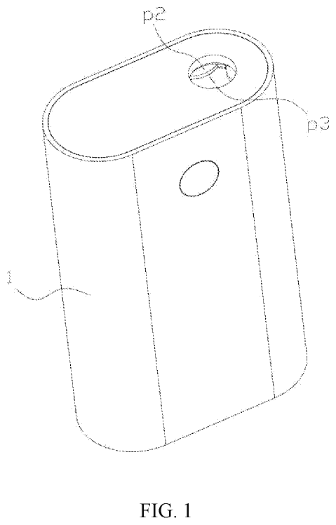

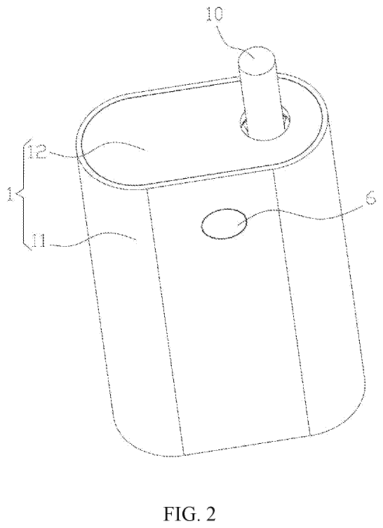

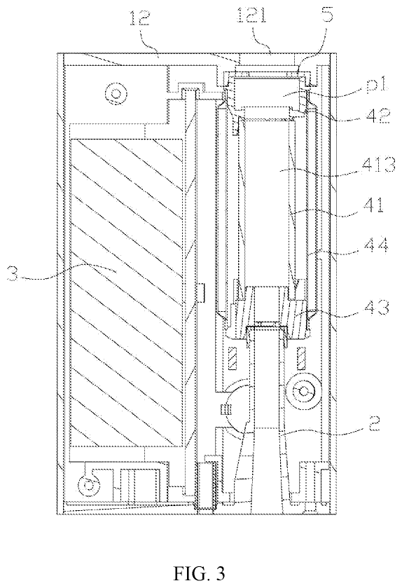

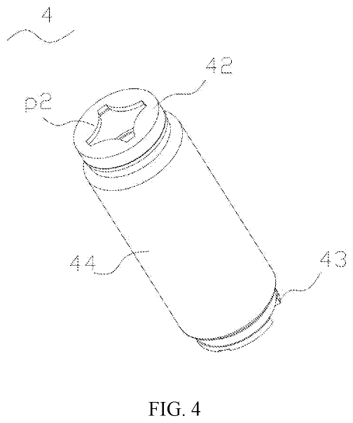

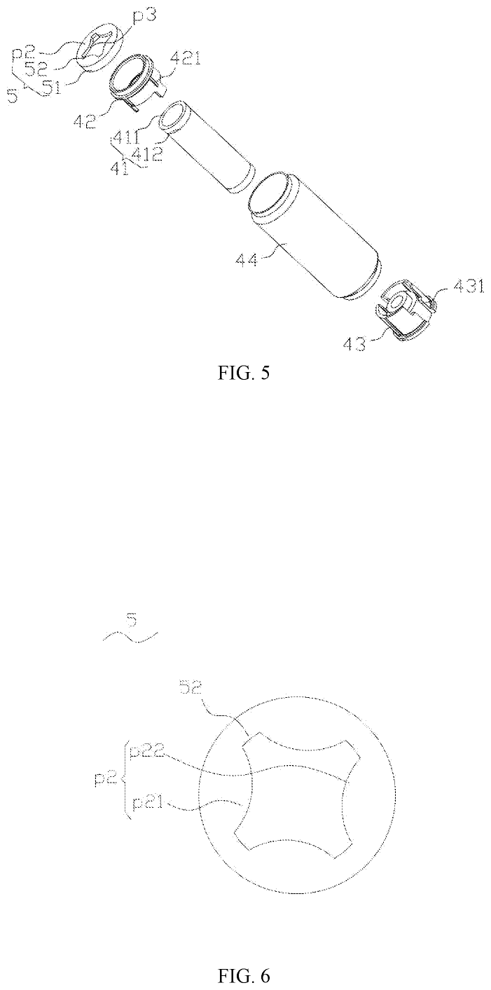

Referring to FIG. 1 to FIG. 6, the present disclosure provides a low-temperature smoking set, including a housing assembly 1, a holder 2, a battery 3, a heating assembly 4 and a cigarette holding mechanism 5, wherein the housing assembly 1 defines thereon a cavity opening 121 used for inserting a cigarette 10, and an inner part of the housing assembly 1 is provided with a cigarette accommodating cavity P1 used for accommodating at least part of the cigarette 10, that is, the cigarette 10, when used, may be partially or totally located within the cigarette accommodating cavity P1. At least one cigarette holding mechanism 5 is disposed at a cavity wall of the cigarette accommodating cavity P1, that is, the number of the cigarette holding mechanism 5 may be one, two, or more, and no concrete limitation is made to the number here.

Specifically, the housing assembly 1 includes a housing sleeve 11 and an end cover 12, wherein the housing sleeve 11 is installed with a button switch 6 that is electrically connected to the battery 3 and the heating assembly 4. The button switch 6 is used for controlling the battery 3 to supply power to the heating assembly 4, so as to heat the cigarette 10. The end cover 12 is arranged to cover an end surface of one end of the housing sleeve 11, and the end cover 12 defines the cavity opening 121. The holder 2 is housed within the housing sleeve 11 and is connected to the housing sleeve 11, the battery 3 is located within the housing sleeve 11 and is installed on the holder 2.

In the present embodiment, the end cover 12 and the holder 2 are both detachably connected to the housing sleeve 11. In certain embodiment, the end cover 12 may be not provided, the holder 2 and the housing sleeve 11 are of an integrated structure. Therefore, no concrete limitation is made to the structures of the housing assembly 1 and the holder 2 here, as long as the battery 3 and the heating assembly 4 can be installed.

The heating assembly 4 is used for heating the cigarette, and the heating assembly, together with the housing assembly 1, defines and forms the cigarette accommodating cavity P1, the cigarette accommodating cavity P1 is provided with a proximal end close to the cavity opening 121 and a distal end away from the cavity opening 121 and extends from the proximal end toward the distal end along an axial line. The cavity wall of the cigarette accommodating cavity P1 is provided with a plurality of deformable elastic protrusion parts P2 that are arranged at intervals along the circumference of the cigarette accommodating cavity P1, the elastic protrusion parts P2 are in the shape of a sheet and extend from the cavity wall of the cigarette accommodating cavity P1 toward an inner part of the cigarette accommodating cavity P1 along the radial direction of the cigarette accommodating cavity P1, the elastic protrusion part P2 is provided with a curved butting surface P3 used for abutting against the cigarette 10. It is understandable that the number of the elastic protrusion parts P2 is two as a minimum, and no concrete limitation is made to the number here.

In one type of embodiments, the elastic protrusion part P2 is disposed at the hole of the cavity opening 121, that is, the elastic protrusion part P2 is located at the cavity opening of the cigarette accommodating cavity P1, thereby better avoiding the problem of deformation of the elastic protrusion part P2 caused by the heat of the heating assembly 4. Of course, the elastic protrusion part P2 may be located at or below the middle part of the cigarette accommodating cavity P1, and no concrete limitation is made to the location here.

In the present embodiment, the heating assembly 4 includes a heating body 41, a first fixing seat 42, a second fixing seat 43 and a heat insulation tube 44, wherein the heating body 41 is used for heating the cigarette 10, the heating body 41 includes a base 411 and an infrared radiation generation layer 412 bonded to a surface of the base 411, the base 411 is in the shape of a tube and is used for accommodating the cigarette 10. The base 411 is provided with opposite first end and second end, the base 411 extends between the first end and the second end along a longitudinal direction and an inner part thereof forms a chamber 413 suitable for housing the cigarette 10.

Herein, the base 411 may be in the shape of a circular tube or a non-circular tube, etc. The base 411 preferably is in the shape of a circular tube, the chamber 413 thus is a circular hole running through the middle part of the base 411, the inner diameter of the hole is slightly greater than the outer diameter of the cigarette, so that the cigarette can be conveniently disposed within the chamber 413 to be heated. It is understandable that in one type of embodiments, the base 411 is in the shape of a tube and an inner part thereof forms the cigarette accommodating cavity P1, that is, the chamber 413 is the cigarette accommodating cavity P1; therefore, no concrete limitation is made to the structure of the cigarette accommodating cavity P1 here, as long as the cigarette accommodating cavity P1 is located within the housing assembly 1. The base 411 may be made of high-temperature resistant and transparent materials such as quartz glass, ceramic or mica, etc., also may be made of other materials with a high infrared transmissivity, for example, high-temperature resistant materials with a high infrared transmissivity above 95%, and no concrete limitation is made here.

The infrared radiation generation layer 412 is formed on the base 411 and is electrically connected to the battery 3 and the button switch 6 through a lead. The infrared radiation generation layer 412 is configured to receive an electric power to generate heat to hereby generate infrared rays, and transfer the energy of the infrared rays to the cigarette 10 at least in a manner of radiation. The infrared radiation generation layer 412 may be an infrared radiation coating applied on an outer surface of the base 411, also may be an infrared radiation coating applied on an inner surface of the base 411. Of course, the infrared radiation generation layer 412 also may be an infrared radiation film wrapped around an outer surface of the base 411, also may be an infrared radiation film wrapped around an inner surface of the base 411. Preferably, the infrared radiation generation layer 412 is an infrared radiation coating applied on an outer surface of the base 411. It is understandable that in one type of embodiments, the infrared radiation generation layer 412 emits infrared rays by receiving the heat of other heating devices and generating infrared rays.

The infrared radiation generation layer 412 when electrified is capable of generating heat, thereby generating infrared rays of certain wavelength, for example, far infrared rays of 8 μm to 15 μm. When the wavelength of the infrared rays is matched with the wavelength absorbed by the cigarette, the energy of the infrared rays is easy to be absorbed by the cigarette. In the embodiments of the present disclosure, no limitation is made to the wavelength of the infrared rays, the infrared rays may be infrared rays of 0.75 μm to 1000 μm, preferably far infrared rays of 1.5 μm to 400 μm.

The infrared radiation generation layer 412 preferably is a mixture of far-infrared electrothermal ink, ceramic powder and inorganic adhesive that is fully stirred and then coated on the surface of the base 411 and finally is dried and cured for certain time, and the infrared radiation generation layer 412 has a thickness of 30 μm-50 μm. Of course, the infrared radiation generation layer 412 can also be a mixture of tin tetrachloride, tin oxide, antimony trichloride, titanium tetrachloride and anhydrous copper sulfate in certain proportion that is stirred and then coated on the outer surface of the base 411; or the infrared radiation generation layer 412 is one of silicon carbide ceramic layer, carbon fiber composite layer, zirconium titanium oxide ceramic layer, zirconium titanium nitride ceramic layer, zirconium titanium boride ceramic layer, zirconium titanium carbide ceramic layer, iron oxide ceramic layer, iron nitride ceramic layer, iron boride ceramic layer, iron carbide ceramic layer, rare earth oxide ceramic layer, rare earth nitride ceramic layer, rare earth boride ceramic layer, rare earth carbide ceramic layer, nickel cobalt oxide ceramic layer, nickel cobalt nitride ceramic layer, nickel cobalt boride ceramic layer, nickel cobalt carbide ceramic layer or high silicon molecular sieve ceramic layer; the infrared radiation generation layer 412 can also be other existing material coatings.

In one type of embodiments, the infrared radiation generation layer 412 is coated on the inner surface of the base 411, the heating assembly 4 further includes a protection layer coated on the infrared radiation generation layer 412 and/or a protection structure element disposed on the infrared radiation generation layer 412. The protection layer may be one or a combination of two of a polytetrafluoroethylene layer and a glaze layer, or a protection layer made of other high-temperature resistant materials. The protection structure element may be a component or part configured to separate the infrared radiation generation layer 412 from the cigarette, and a gap may exist between the protection structure element and the infrared radiation generation layer 412 or the cigarette. The protection layer and/or protection structure element may avoid, for example, abrasion of the infrared radiation generation layer 412 caused by the cigarette entering and exiting the chamber 413. It is understandable that in some embodiments an electric heating circuit may be employed to substitute the infrared radiation generation layer 412, as long as it can heat the cigarette, and no concrete limitation is made to the heating mode here.

The first fixing seat 42 is sleeved on the first end of the heating body 41, and is connected to the heating body 41 and the housing assembly 1. The cigarette holding mechanism 5 is detachably sleeved on the first fixing seat 42, thus being convenient to replace and maintain. The cigarette holding mechanism 5 is disposed at the proximal end of the cigarette accommodating cavity P1, including a sleeving ring part 51, a connection part 52 and the elastic protrusion part P2, wherein the sleeving ring part 51 is sleeved on the first fixing seat 42, one end of the sleeving ring part 51 extends toward an axial center of the sleeving ring part 51 to form a plurality of the elastic protrusion parts P2, and the plurality of the elastic protrusion parts P2 are equidistantly disposed. Specifically, the elastic protrusion parts P2 include a first elastic protrusion part P21 and a second elastic protrusion part P22, the first elastic protrusion part P21 and the second elastic protrusion part P22 are symmetrical with respect to the axial line of the cigarette accommodating cavity P1, so that the cigarette is uniformly stressed when clamped.

Preferably, a spacing between the first elastic protrusion part P21 and the second elastic protrusion part P22 along the radial direction of the cigarette accommodating cavity P1 is less than a caliber of the cavity opening 121, enabling a relatively great clamping force. The elastic protrusion part P2 is provided with a curved butting surface P3 used for abutting against the cigarette, thereby preventing the cigarette 10 being scratched when the cigarette 10 is being inserted and extracted.

One end of the connection part 52 is connected to one of the elastic protrusion parts P2 and the other end of the connection part 52 is connected to another of the elastic protrusion parts P2, that is, one connection part 52 is connected between adjacent elastic protrusion parts P2, so that the elastic protrusion parts P2 are easy to restore when the cigarette is extracted. Preferably, the sleeving ring part 51 is connected to the connection part 52, the connection part 52 and the elastic protrusion part P2 extend along and within one same plane that is perpendicular to the axial line of the cigarette accommodating cavity P1, thereby improving the restoration capability of the elastic protrusion part P2 and prolonging the service life. In the present embodiment, the cigarette holding mechanism 5 is a part made of a silicone rubber material and is of an integrated structure, which is not only convenient to manufacture, but also not prone to scratch the cigarette 10 when the cigarette 10 is being inserted. It is understandable that no concrete limitation is made to the material of the cigarette holding mechanism 5 here.

An outer circumferential surface of the first fixing seat 42 is provided with a plurality of convex ribs 421, and the plurality of convex ribs 421 are disposed extending along the length direction of the first fixing seat 42. An outer circumferential surface of the second fixing seat 43 is provided with a lead groove 431, and the lead groove 431 is disposed extending along the length direction of the second fixing seat 43, for the lead connected between the battery 3 and the infrared radiation generation layer 412 to pass through. The first end of the heating body 41 is inserted into the first fixing seat 42, the second end of the heating body 41 is inserted into the second fixing seat 43, and the second fixing seat 43 is connected to the holder 2, so that the heating body 41 can be reliably fixed. A first end of the heat insulation tube 44 is sleeved on the convex ribs 421 on the outer circumferential surface of the first fixing seat 42, a second end of the heat insulation tube 44 is sleeved on the outer circumferential surface of the second fixing seat 43, and a gap is formed between the heat insulation tube 44 and the heating body 41, thereby preventing heat being radiated to outside to burn users or cause discomfort to users. Due to the arrangement of the convex ribs 421, when the first end of the heat insulation tube 44 is sleeved on the second fixing seat 43, the convex ribs 421 generates deformation to facilitate assembly.

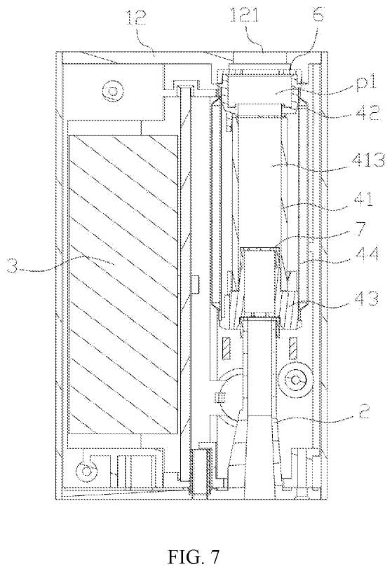

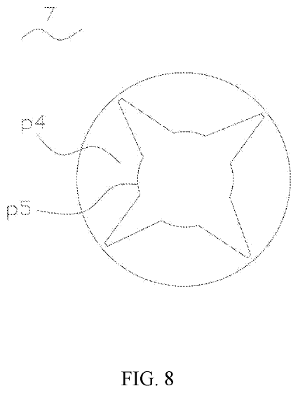

Referring to FIG. 7 and FIG. 8, which is a perspective view of a cigarette holding mechanism in the low-temperature smoking set according to another embodiment of the present disclosure; the present embodiment is similar to the above embodiment in structure, with the difference lying in that: the cigarette holding mechanism of the present embodiment includes a first cigarette holding mechanism 6 located at the proximal end of the cigarette accommodating cavity P1 and a second cigarette holding mechanism 7 located at the distal end of the cigarette accommodating cavity P1, wherein the first cigarette holding mechanism 6, in structure, is the same as the cigarette holding mechanism described in the above embodiment, thus the structure of the first cigarette holding mechanism 6 is no longer described in detail here.

The second cigarette holding mechanism 7 is sleeved on the second fixing seat 43, including a plurality of third elastic protrusion parts P4 that are disposed equidistantly, wherein the third elastic protrusion parts P4 are in the shape of a fan, the third elastic protrusion part P4 is provided with a curved butting surface P5, and all of the curved butting surfaces P5 are disposed to form an opening ring, thereby being better adapted to the shape of the cigarette 10 and enabling a stable clamping. It is understandable that in one type of embodiments, the second cigarette holding mechanism 7 is the same as the first cigarette holding mechanism 6 in structure.

To sum up, at least one cigarette holding mechanism 5 is disposed at the cavity wall of the cigarette accommodating cavity P1, the cigarette holding mechanism 5 includes at least two deformable elastic protrusion parts P2 arranged at intervals along the circumference of the cigarette accommodating cavity P1, and the elastic protrusion part P2 is used for abutting against the cigarette, therefore, when a cigarette with a greater diameter is inserted into the cigarette accommodating cavity P1, the elastic protrusion part P2 generates an elastic deformation such that the cigarette can be inserted into the cigarette accommodating cavity P1, thereby implementing adaptive adjustment according to the diameter of the cigarette so as to adapt to cigarettes of different diameters. In addition, since the elastic protrusion parts P2 are in the shape of a sheet and extend from the cavity wall of the cigarette accommodating cavity P1 toward the inner part of the cigarette accommodating cavity P1 along the radial direction of the cigarette accommodating cavity P1, heat dissipation may be better prevented, thereby ensuring the heating efficiency of the cigarette.

It is to be noted that the description of the present disclosure and the drawings just list preferred embodiments of the present disclosure and are not limited to the embodiments described herein. Further, for the ordinary staff in this field, improvements or variations may be made according to the above description, and all these improvements or variations are intended to be included within the scope of protection of the claims appended hereinafter.

What is claimed is:

1. A low-temperature smoking set, comprising a housing assembly and a heating assembly disposed inside the housing assembly, the housing assembly defining thereon a cavity opening used for inserting a cigarette, and an inner part of the housing assembly being provided with a cigarette accommodating cavity used for accommodating at least part of the cigarette, wherein at least one cigarette holding mechanism is disposed at a cavity wall of the cigarette accommodating cavity, the cigarette holding mechanism comprises at least two deformable elastic protrusion parts arranged at intervals along the circumference of the cigarette accommodating cavity, the elastic protrusion parts are in the shape of a sheet and extend from the cavity wall of the cigarette accommodating cavity toward an inner part of the cigarette accommodating cavity along the radial direction of the cigarette accommodating cavity.

2. The low-temperature smoking set according to claim 1, wherein the cigarette accommodating cavity is provided with a proximal end close to the cavity opening and a distal end away from the cavity opening and extends from the proximal end toward the distal end along an axial line, and the at least one cigarette holding mechanism is disposed at the proximal end of the cigarette accommodating cavity.

3. The low-temperature smoking set according to claim 1 or 2, wherein the cigarette holding mechanism comprises a first elastic protrusion part and a second elastic protrusion part, the first elastic protrusion part and the second elastic protrusion part are symmetrical with respect to the axial line of the cigarette accommodating cavity.

4. The low-temperature smoking set according to claim 3, wherein a spacing between the first elastic protrusion part and the second elastic protrusion part along the radial direction of the cigarette accommodating cavity is less than a caliber of the cavity opening.

5. The low-temperature smoking set according to claim 2, wherein the at least one cigarette holding mechanism comprises a first cigarette holding mechanism located at the proximal end of the cigarette accommodating cavity and a second cigarette holding mechanism located at the distal end of the cigarette accommodating cavity.

6. The low-temperature smoking set according to claim 1 or 2, wherein the elastic protrusion part is provided with a curved butting surface used for abutting against the cigarette.

7. The low-temperature smoking set according to claim 1 or 2, wherein the heating assembly comprises a base and an infrared radiation generation layer bonded to a surface of the base, the base is in the shape of a tube and an inner part thereof forms the cigarette accommodating cavity.

8. The low-temperature smoking set according to claim 1 or 2, wherein the heating assembly comprises a heating body and a first fixing seat, the heating body is used for heating the cigarette, and the first fixing seat is connected to the heating body;
the cigarette holding mechanism further comprises a sleeving ring part and a connection part, the sleeving ring part is sleeved on the first fixing seat, one end of the sleeving ring part extends toward an axial center of the sleeving ring part to form a plurality of the elastic protrusion parts, one end of the connection part is connected to one of the elastic protrusion parts and the other end of the connection part is connected to another of the elastic protrusion parts.

9. The low-temperature smoking set according to claim 8, wherein the connection part and the elastic protrusion part extend along and within one same plane that is perpendicular to the axial line of the cigarette accommodating cavity.

10. The low-temperature smoking set according to claim 1 or 2, wherein the cigarette holding mechanism is a part made of a silicone rubber material.
